(19) United States
(12) Patent Application Publication
(10) Pub. No.: US 2010/0033968 A1
(43) Pub. Date: Feb. 11, 2010

(54) LIGHT INFORMATION MODULE

(75) Inventors: Victor Vasilievich Kachkin, Moscow (RU); Vladimir Fyodorovich Solinov, Moscow (RU); Yury Alexandrovich Khabarov, Moskovskaya (RU); Arkadiy Gennadievich Mityashin, Moscow (RU)

Correspondence Address: ARENT FOX LLP, 1050 CONNECTICUT AVENUE, N.W., SUITE 400, WASHINGTON, DC, 20036, US

(73) Assignee: Infoglass Group International Limited, Wanchai (HK)

(21) Appl. No.: 12/445,428

(22) PCT Filed: Oct. 23, 2007
(86) PCT No.: PCT/EA2007/000009

§ 371 Date: Apr. 13, 2009

(30) Foreign Application Priority Data
Dec. 28, 2006 (EA) 200700302

(51) Int. Cl. F21S 4/00

(52) U.S. Cl. 362/249.02

(57) ABSTRACT

A light-information module including a foundation on which there are fixed tubular light-conducting elements with luminous sources mounted therein, wherein a light-emitting armature is located within each of the light-conducting elements, said light-emitting armature including at least one group of parallel conductors, wherein each of the conductors includes a thin copper wire, each of the conductors is situated in a plane with the other conductors, each of the conductors has a length coinciding to that of the light-conducting element, and each of the conductors is provided with a S-shaped compensator. The light-emitting armature also includes at least one set of luminous sources, each including transistorized light emitting diodes, connected between each other and forming a full-color pixel by means of compact printed circular boards, having contact areas on one side thereof to fix said at least one set of luminous sources on said parallel conductors by welding or soldering.

### BACKGROUND

The present disclosure relates to a light-information module, and more particularly, to a device capable of displaying static and dynamic information.

Light-information modules may be incorporated in to a vast number of applications, such as illuminated advertising, visual representation of information, and design decoration and highlighting.

Such devices are generally implemented in printed circuit boards for electrical assemblage of all luminous sources, particularly while using transistorized light emitting diodes in systems of visualization of dynamic information.

A typical light-information device may include a body with an inspection window, on the electrically insulated foundation of which there are mounted printed circuit boards with light-conducting elements disposed thereon. Apart from that, the typical device may comprise a controller module and a power-supply source. An example of such a device may be found in Patent DE No. 10006092, G09F9/33.

This device, however, has many disadvantages, such as the complexity of construction with respect to securing impermeability, specific consumption of materials, and an inability to use the device on transparent surfaces due to its construction.

The closest technical solution to the offered one is a light-information device including a foundation and a light-conducting element, inside of which there are installed luminous sources, foundation of which is designed in the form of a data entry or a picturesque element, to which there is fastened a light-conducting element made from a flexible, light-transmitting, electrically insulating, frost-hardy and heat-resistant tube, inside of which a flexible electrically-conducting panel is disposed, on which there are fastened luminous sources, which are joined-up in parallel between each other. An example of such a device may be found in Patent RU No. 2090941, G09F13/00.

The flexible, light-transmitting, electrically insulating, frost-hardy and heat-resistant tube is made from polyvinyl chloride, and the flexible electrically-conducting panel is more than one half of the flexible light-transmitting tube diameter, and its height is not more than a diameter of a luminous source bowl.

In capacity of luminous sources there are used subminiature incandescent lamps, where one set of the lamp outlets are fastened (soldered) to one side of the panel, and another set of the lamp outlets are fastened to the other side of the panel. Moreover, the distance between the sources is equal to not less than 2 cm.

The light-conducting element is fastened along the perimeter or along the symmetry axis of the data entry or the decorative element.

This device, however, also has many disadvantages, such as complexity of construction, application of printed circuit boards of a large length for assemblage of luminous sources, short operational life of incandescent lamps in comparison with light-conducting elements, absence of a possibility of dynamic modification of color layout, unclear visual display of information, low light transparency of the light-conducting element due to application of printed circuit boards along the entire length of the light-conducting element.

Aspects of the present invention aim to increase the quality of visually displayed information and of demonstrational effect, owing to the possibility of visualization of full-color video information, enhancement of device reliability and durability, expansion of service life, and possibility of application onto transparent surfaces due to proper high transparency.

### SUMMARY

Aspects of the present invention include a light-information module, including a foundation and tubular light-conducting elements, in the interior of which there are installed luminous sources as part of light-emitting armature that has as part of its composition a group of separate parallel conductors manufactured from bare copper wire of small diameter (e.g., 0.3-0.7 mm), arranged in one plane and having a length coinciding with the length of the light-conducting element. The pitch between the conductors corresponds to the pitch of contact areas serving for connecting the luminous sources in the process of their combination into a single light-emitting armature for further assemblage into a transparent tube formed, for example, from polycarbonate. The light-emitting armature, when arranged in a vertical direction and being in tension state, has an S-shaped compensator 10, formed at each conductor. Apart from that, the light-emitting armature is fastened to a thin plastic plate providing additional steadiness to the light-emitting armature while using it in a non-tension state or in a horizontal arrangement. A plurality of light-emitting armatures may be disposed in a single light-transparent leak-proof body (not shown).

### BRIEF DESCRIPTION OF THE DRAWINGS

FIG. 1 shows a general view of the light-information module; and

FIG. 2 shows a side view of a tube 3, and a light-emitting armature provided with luminous sources.

### DETAILED DESCRIPTION

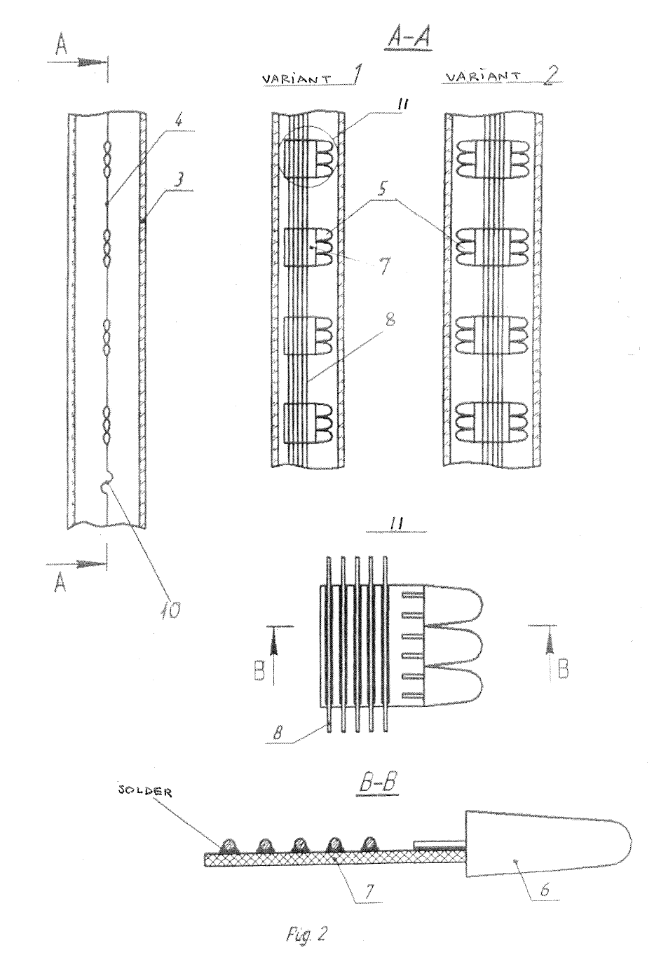

As shown in FIG. 1, the light-information module may include a foundation 1 in the form of a frame. To the foundation 1 there may be fastened a light-conducting element 2, which may be formed from a light-transparent polycarbonate tube 3, for example.

As shown in FIG. 2, in the interior of the tube 3 there may be arranged a light-emitting armature 4, The light-emitting armature 4 may include luminous sources 5, in the capacity of which there are applied transistorized light emitting diodes, connected between each other by means of miniature printed circuit board 7 into miniature devices 11, each of which form full-color pixels (e.g., luminous sources). It is important to note that all pixels, which altogether make up 95% of the whole system, are identical to one another.

The light-conducting element 2 is fastened by a fastening element (not shown) to the foundation 1.

FIG. 2 also shows a variant 1 and a variant 2 of forming the light-emitting armature 4. In Variant 1, the luminous sources 5 are connected to the miniature printed circuit board 7 at one of its surfaces. In variant 2, the luminous sources 5 are connected to the miniature printed circuit board 7 at both of its surfaces.

FIG. 2 also shows an enlarged view of miniature device 11 and the cross-section thereof along line “B-B”. As shown in FIG. 2, the miniature device 11 is fastened to a group of metal conductors 8 fixed to the frame 1 so as to be arranged in one plane with a pitch therebetween. The miniature device 11 has a miniature printed circuit board 7 with contact areas arranged with the same pitch therebetween. Metal wire conductors are fastened (e.g., soldered) to the miniature printed circuit board 7 at the contact areas. Luminous sources (e.g., diodes) 5 are also connected to the miniature printed circuit board 7. Thus, the miniature device 11 forms the full-color pixel. Said devices fastened to the wire conductors form a light-emitting armature 4. The light-emitting armature 4 is mounted in the interior of tube 3 forming a light-conducting element.

The light-information module is easy to manufacture, and it may be manufactured by assembling (e.g., soldering) the light-emitting armature 4 from luminous sources by means of thin copper-made conductors, and then mounting the assembled armature 4 into a light-transparent tube 3, which is then fastened to a foundation 1 designed in the form of a frame.

The main difference between the disclosed light-information module and other devices is its enhanced reliability, light weight, and high transparency. These advantages are the result of the construction of the light-emitting armature that includes metal conductors having a minimal diameter (e.g., from 0.3 to 0.5 mm), arranged in one plane and combining luminous sources, as shown in FIG. 2. This construction allows the light-emitting armature to be bent (e.g., folded) with a radius equal to 0. Absence of a supporting insulator, as it is, for example, in printed circuit boards, which are used in most video-information systems, dramatically enhances reliability when using under different environmental temperature conditions due to the absence of large surfaces having very different coefficients of linear expansion (e.g., plastic and copper), and allows achieving very high transparency of the whole module in translucent light, approximately 75-90%. Also contributing is the fact that a control system can be disposed at a great distance from the light-information module.

With the help of the suggested construction of the light-information module it is possible to manufacture various kinds of illuminated advertisements and video-information systems. By means of choosing different dimensions for the whole system, as well as a form of its design, it is possible to obtain good demonstrational effect and clear visual perception of a light and artistic solution.

In comparison with various light-information devices, the suggested light-information module is easy to manufacture, reliable in operation, ecological, it is possessed of long-continued service life, and it has high transparency.

Possibility of arrangement of the light-information module onto transparent surfaces, or of being built-in into them, allows expanding possibilities of the suggested light-information module with respect to its application in advertising and information purposes.

1-4. (canceled)

5. A light-information module, comprising:
a foundation made as a frame on which there are fixed tubular light-conducting elements with luminous sources mounted therein, wherein a light-emitting armature is located within each of the light-conducting elements, said light-emitting armature comprising:
at least one group of parallel conductors, wherein:
each of the conductors is situated in one and the same plane with the other conductors,
each of the conductors has a length coinciding with a length of the light-conducting element, and
each of the conductors is provided with a S-shaped compensator at one of the ends thereof; and
at least one set of luminous sources, each of which comprises transistorized light emitting diodes, connected between each other and forming a full-color pixel by means of compact printed circular boards, having contact areas on one side thereof to fix said at least one set of luminous sources on said parallel conductors by welding or soldering.

6. The light-information module according to claim 5, wherein a plurality of said light-emitting armatures are disposed in a light-transparent leak-proof body.

7. The light-information module according to claim 5, wherein each of the parallel conductors comprises a copper wire having a diameter of 0.3-0.7 mm.
